(19) United States
(12) Patent Application Publication
(10) Pub. No.: US 2026/0200303 A1
(43) Pub. Date: Jul. 16, 2026

(54) WINDOW GLASS RECEIVING STRUCTURE

(71) Applicant: Honda Motor Co., Ltd., Tokyo (JP)

(72) Inventors: Kazunori HIDA, Tokyo (JP); Seiichi KATO, Tokyo (JP); Yohei INAI, Tokyo (JP); Ryo SUESADA, Tokyo (JP); Taiga MARUKAWA, Tokyo (JP)

(73) Assignee: Honda Motor Co., Ltd., Tokyo (JP)

(21) Appl. No.: 19/441,710

(22) Filed: Jan. 6, 2026

(30) Foreign Application Priority Data
Jan. 10, 2025 (CN) 202510040804.2

(51) Int. Cl. B60J 10/32; B60J 10/77

(52) U.S. Cl. CPC B60J 10/32; B60J 10/77

(57) ABSTRACT

The window glass receiving structure is adapted to be disposed within a sashless door-type vehicle, and includes: a frame component having a closed cross section; an outer panel disposed on an outer side of the frame component to form an outer surface of the sashless door-type vehicle; a window glass receiving space disposed between an end portion of the outer panel and the frame component to receive window glass; and a retainer disposed within the window glass receiving space to secure a seal of the window glass.

### CROSS-REFERENCE TO RELATED APPLICATION

This application claims the priority benefit of China application serial no. 202510040804.2, filed on January 10, 2025. The entirety of the above-mentioned patent application is hereby incorporated by reference herein and made a part of this specification.

### BACKGROUND

### Technical Field

The disclosure relates to a window glass receiving structure.

### Description of Related Art

In the prior art (for example, Japanese Patent Publication No. 6861228), a sashless door-type vehicle is disclosed in which the window doors are omitted and the window glass is directly mounted on the frame component and the outer panel. The window glass receiving structure applicable to the sashless door-type vehicle may use a garnish to cover a retainer and a weather strip that secure the window glass to obtain an appearance with minimal surface level difference. However, given that such an approach requires an additional component such as a garnish, it results in a higher cost. Therefore, in order to enhance appearance quality at a low cost, it is necessary to improve the window glass receiving structure.

### SUMMARY

The disclosure provides a window glass receiving structure that may enhance appearance quality at a low cost.

The disclosure provides a window glass receiving structure adapted to be disposed within a sashless door-type vehicle, and includes: a frame component having a closed cross section; an outer panel disposed on an outer side of the frame component to form an outer surface of the sashless door-type vehicle; a window glass receiving space disposed between an end portion of the outer panel and the frame component to receive window glass; and a retainer disposed within the window glass receiving space to secure a seal of the window glass.

Based on the above, in the window glass receiving structure of the disclosure, the window glass receiving space is disposed between the end portion of the outer panel and the frame component to accommodate the window glass, and the retainer is disposed within the window glass receiving space to secure the seal of the window glass. Thereby, the retainer is hidden inside the window glass receiving space without requiring the use of an additional component such as a garnish, thus enabling the window glass to be provided with a simple structure. Accordingly, the window glass receiving structure of the disclosure may enhance appearance quality at a low cost.

In order to make the above-mentioned features and advantages of the disclosure comprehensible, embodiments accompanied with drawings are described in detail below.

### BRIEF DESCRIPTION OF THE DRAWINGS

FIG. 1 is a schematic side view of a window glass receiving structure of the first embodiment of the disclosure.

FIG. 2 is a schematic cross-sectional view of the window glass receiving structure shown in FIG. 1 taken along line A-A'.

FIG. 3 and FIG. 4 are schematic side views of a fixture used in variation examples of the window glass receiving structure shown in FIG. 2.

FIG. 5 is a schematic cross-sectional view of a window glass receiving structure of the second embodiment of the disclosure.

FIG. 6 is a schematic cross-sectional view of a window glass receiving structure of the third embodiment of the disclosure.

### DESCRIPTION OF THE EMBODIMENTS

In an embodiment of the window glass receiving structure of the disclosure, the retainer has an outer flange, and is fixed to an inner side of the outer panel via the outer flange.

In an embodiment of the window glass receiving structure of the disclosure, one end of the outer panel has a bent portion bent inwardly, and the outer flange is clamped by the bent portion.

In an embodiment of the window glass receiving structure of the disclosure, the retainer has an inner flange, and is fixed to the frame component via the inner flange.

In an embodiment of the window glass receiving structure of the disclosure, the retainer is fixed to the frame component via a bracket mounted on the frame component.

In an embodiment of the window glass receiving structure of the disclosure, the frame component has an opposing surface disposed opposite to a bottom of the retainer, and the retainer is fixed to the opposing surface.

In an embodiment of the window glass receiving structure of the disclosure, the retainer is fixed to the opposing surface via a fixture.

In an embodiment of the window glass receiving structure of the disclosure, the fixture may adjust a fixed position of the retainer relative to the opposing surface.

In an embodiment of the window glass receiving structure of the disclosure, the fixture has a lateral side that presses against the opposing surface and a sidewall of a through hole through which the fixture passes.

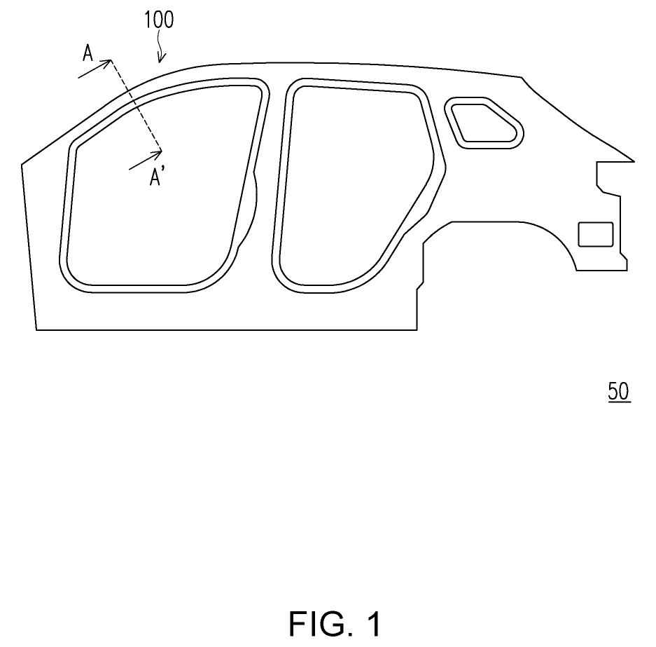

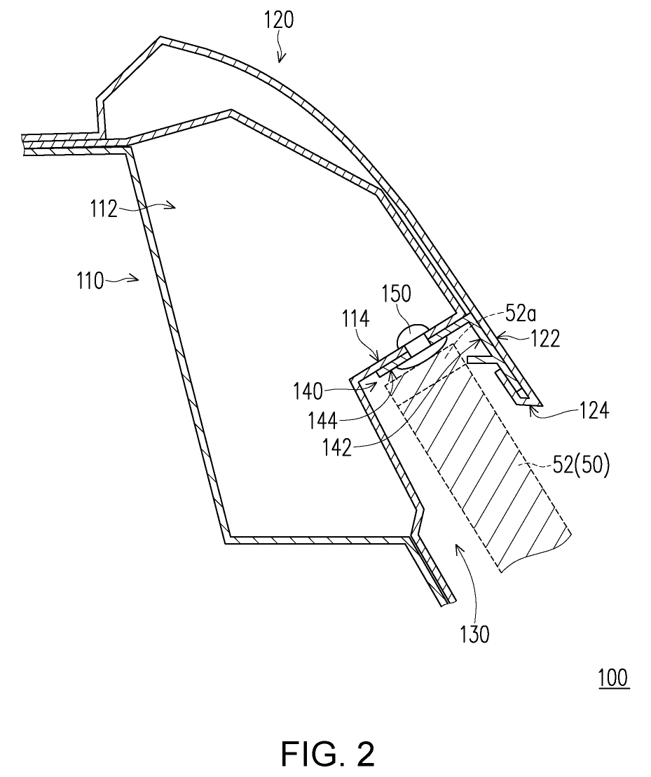

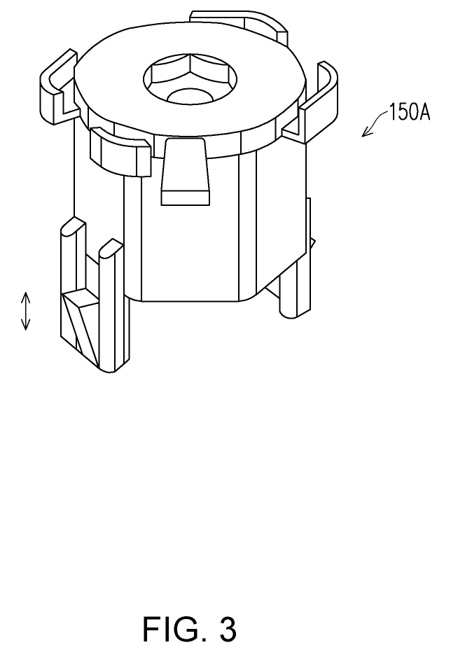

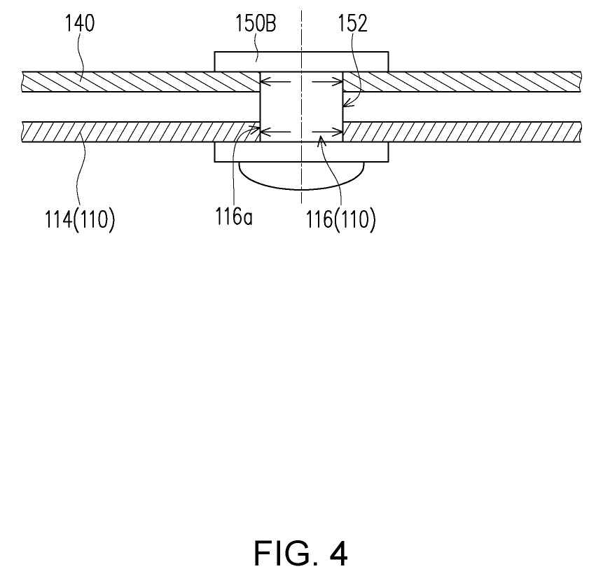

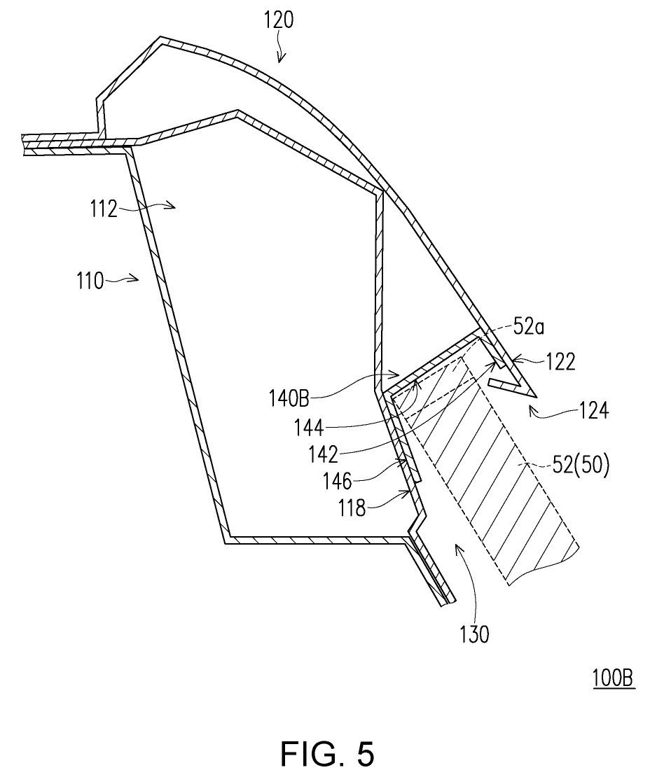

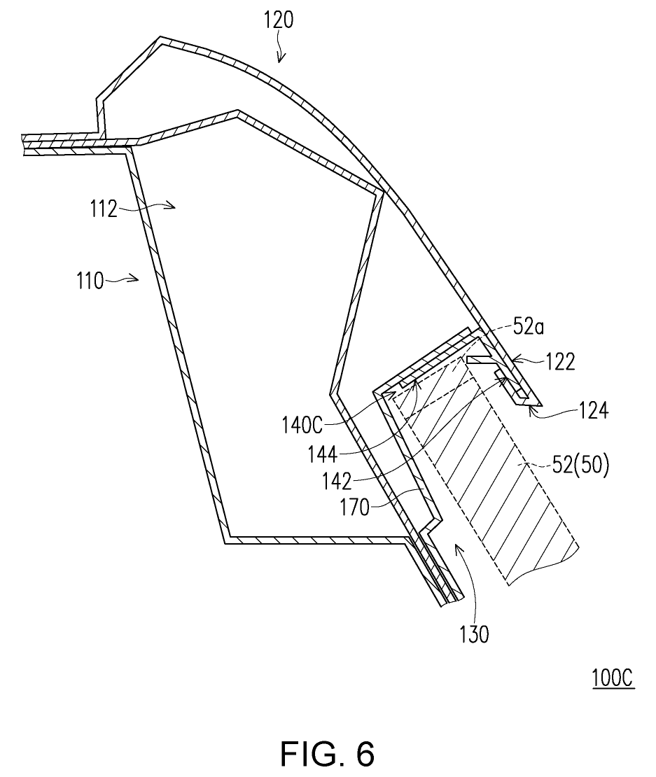

Reference is now made in detail to exemplary embodiments of the disclosure, and examples of the exemplary embodiments are described in the accompanying drawings. FIG. 1 is a schematic side view of a window glass receiving structure of the first embodiment of the disclosure. FIG. 2 is a schematic cross-sectional view of the window glass receiving structure shown in FIG. 1 taken along line A-A'. FIG. 3 and FIG. 4 are schematic side views of a fixture used in variation examples of the window glass receiving structure shown in FIG. 2. FIG. 5 is a schematic cross-sectional view of a window glass receiving structure of the second embodiment of the disclosure. FIG. 6 is a schematic cross-sectional view of a window glass receiving structure of the third embodiment of the disclosure. The specific structures of the window glass receiving structures 100, 100B, 100C of multiple embodiments of the disclosure will be illustrated below with reference to FIG. 1 to FIG. 6, but these are only some examples of the disclosure, and the disclosure is not limited thereto.

Referring to FIG. 1 and FIG. 2, in the first embodiment of the disclosure, the window glass receiving structure 100 is adapted to be disposed within a sashless door-type vehicle 50, and includes a frame component 110, an outer panel 120, a window glass receiving space 130, and a retainer 140. The frame component 110 has a closed cross section 112 (as shown in FIG. 2). The outer panel 120 is disposed on the outer side of the frame component 110 to form the outer surface of the sashless door-type vehicle 50. The window glass receiving space 130 is disposed between an end portion 122 of the outer panel 120 and the frame component 110 to receive window glass 52 (as shown by the dashed line in FIG. 2). The retainer 140 is disposed within the window glass receiving space 130 to secure a seal 52a of the window glass 52 (as shown by the dashed line in FIG. 2).

Specifically, in the embodiment, as shown in FIG. 2, the frame component 110 refers to a vehicle body framework of the sashless door-type vehicle 50, and is formed by at least one panel to have a closed cross section 112. The outer panel 120 refers to a panel structure that serves as the outer surface of the sashless door-type vehicle 50, and is disposed on the outer side of the frame component 110 in a manner that covers the outer surface of the frame component 110. Furthermore, the window glass receiving space 130 refers to a receiving structure for receiving at least a portion of the window glass 52, and may be formed, for example, by a recessed portion of the frame component 110 corresponding to the end portion 122 of the outer panel 120, but not limited thereto. In addition, the retainer 140 refers to a frame structure for securing the seal 52a of the window glass 52, and is provided, for example, on the wall surface of the frame component 110 that forms the window glass receiving space 130. However, the disclosure does not limit the specific structures of the frame component 110, the outer panel 120, the window glass receiving space 130, and the retainer 140, which may be adjusted according to requirements.

Through the above configuration, in the window glass receiving structure 100 of the embodiment, the window glass receiving space 130 is disposed between the end portion 122 of the outer panel 120 and the frame component 110 to receive the window glass 52, and the retainer 140 is disposed within the window glass receiving space 130 to secure the seal 52a of the window glass 52. In this way, the retainer 140 is hidden inside the window glass receiving space 130 without requiring the use of an additional component such as a garnish, thus enabling the window glass 52 to be provided with a simple structure. Accordingly, the window glass receiving structure 100 may enhance appearance quality at a low cost. However, the disclosure does not limit the structural composition of the window glass receiving structure 100, which may be adjusted according to requirements.

More specifically, in the embodiment, as shown in FIG. 2, the retainer 140 has an outer flange 142, and is fixed to the inner side of the outer panel 120 via the outer flange 142. Furthermore, one end of the outer panel 120 (for example, the end portion 122) has a bent portion 124 bent inwardly, and the outer flange 142 is clamped by the bent portion 124. As an example, the retainer 140 is bent to form the outer flange 142 at the outer end portion corresponding to the outer panel 120, and the retainer 140 is fixed to the inner side of the outer panel 120 in a manner where the outer flange 142 is clamped by the bent portion 124, thereby enabling the retainer 140 and the outer panel 120 to be fixed together. In this way, the retainer 140 may be supported by the outer panel 120 and the deviation between the end portions of the outer panel 120 corresponding to the outer flange 142 may be suppressed, so that the window glass receiving structure 100 may further enhance appearance quality. Moreover, the retainer 140 may be more firmly supported by the outer panel 120 through the clamping of the bent portion 124 of the outer panel 120. However, the disclosure does not limit the fixing means of the retainer 140 and the outer panel 120, or limit the specific structure (or setting) of the outer flange 142 and the bent portion 124, which may be adjusted according to requirements.

Additionally, in the embodiment, as shown in FIG. 2, the frame component 110 has an opposing surface 114 disposed opposite to a bottom 144 of the retainer 140, and the retainer 140 is fixed to the opposing surface 114. Moreover, the retainer 140 is fixed to the opposing surface 114 via a fixture 150. Specifically, the retainer 140 is configured to have a substantially L-shaped structure in cross section, and has an outer flange 142 fixed to the end portion 122 of the outer panel 120, and a bottom 144 fixed to the opposing surface 114 of the frame component 110. As one of the fixing means, the fixture 150 is, for example, a bolt that enables the retainer 140 and the frame component 110 to be fixed together, but not limited thereto. In this way, the retainer 140 may be supported by the frame component 110 having a high structural strength with a closed cross section 112, and may be even more firmly supported by the frame component 110 by being fixed via the fixture 150 to the frame component 110. Moreover, by directly fixing the retainer 140 to the frame component 110, the use of an additional mounting component (such as a bracket) may be omitted. However, the disclosure does not limit the fixing means of the retainer 140 and the frame component 110, or limit the specific structure (or setting) of the fixture 150, which may be adjusted according to requirements.

Furthermore, in the variation example shown in FIG. 3, the main difference from the aforementioned fixture 150 is that the fixture 150A may adjust the fixed position of the retainer 140 shown in FIG. 2 relative to the opposing surface 114. As an example, the fixture 150A is, for example, an adjustment screw capable of adjusting length (as shown by the arrow in FIG. 3), but not limited thereto. By replacing the fixture 150 shown in FIG. 2 with the fixture 150A shown in FIG. 3, the bottom 144 of the retainer 140 shown in FIG. 2 is fixed to the opposing surface 114 of the frame component 110 shown in FIG. 2 via the fixture 150A shown in FIG. 3, and the fixed position of the retainer 140 may be adjusted by adjusting the length of the fixture 150A (for example, by tightening the fixture 150A to bring the retainer 140 and the frame component 110 closer together). In this way, even when there is accuracy deviation in the frame component 110, the fixture 150A may be used to adjust the fixed position of the retainer 140 relative to the opposing surface 114. However, the disclosure does not limit the fixing means of the retainer 140 and the frame component 110, or limit the specific structure (or setting) of the fixture 150A, which may be adjusted according to requirements.

Furthermore, in the variation example shown in FIG. 4, the main difference from the aforementioned fixtures 150, 150A is that the fixture 150B has a lateral side that presses against the opposing surface 114 of the frame component 110 and a sidewall 116a of a through hole 116 through which the fixture 150B passes. As an example, the fixture 150B is, for example, a rivet with a widened lateral side 152, but not limited thereto. By replacing the fixture 150 shown in FIG. 2 with the fixture 150B shown in FIG. 4, the fixture 150B may penetrate the through hole 116 under pressure, thereby enabling the lateral side 152 to press against the opposing surface 114 and the sidewall 116a of the through hole 116 through which the fixture 150B passes. In this way, a predetermined gap is maintained even after the frame component 110 and the retainer 140 are riveted through the fixture 150B, and the frame component 110 may hold the retainer 140 with the pressing force of the fixture 150B, so that the retainer 140 may be held in a normal position even in a state where a gap exists. However, the disclosure does not limit the fixing means of the retainer 140 and the frame component 110, or limit the specific structure (or setting) of the fixture 150B, which may be adjusted according to requirements.

Furthermore, in the second embodiment shown in FIG. 5, the window glass receiving structure 100B has a similar structural configuration to the aforementioned window glass receiving structures 100, 100A, with the main difference being that in the window glass receiving structure 100B, a retainer 140B has an inner flange 146 and is fixed to the frame component 110 via the inner flange 146. As an example, the retainer 140B is bent to form the inner flange 146 at the inner end portion corresponding to the frame component 110, and the retainer 140B is fixed to the outer side of the frame component 110 via the inner flange 146, so that the retainer 140B is configured to have a substantially lid-like structure in cross section. The outer flange 142 is fixed to the end portion 122 of the outer panel 120, and the inner flange 146 is fixed to an outer side surface 118 of the frame component 110, thereby enabling the retainer 140B and the frame component 110 to be fixed together. In this way, the window glass receiving structure 100B may omit the aforementioned fixture 150. The retainer 140B may be supported by the frame component 110 having a high structural strength with a closed cross section 112, and may be even more firmly supported by the frame component 110 by being fixed via the inner flange 146 to the frame component 110. Moreover, by directly fixing the retainer 140B to the frame component 110, the use of an additional mounting component (such as a bracket) may be omitted. However, the disclosure does not limit the fixing means of the retainer 140B and the frame component 110, the specific structure of the retainer 140B, or the setting of the inner flange 146, which may be adjusted according to requirements.

Furthermore, in the third embodiment shown in FIG. 6, the window glass receiving structure 100C has a similar structural configuration to the aforementioned window glass receiving structures 100, 100A, 100B, with the main difference being that in the window glass receiving structure 100C, the retainer 140C is fixed to the frame component 110 via a bracket 170 mounted on the frame component 110. As an example, the retainer 140C is configured to have a substantially L-shaped structure in cross section, and has an outer flange 142 fixed to the end portion 122 of the outer panel 120, and a bottom 144 fixed to the frame component 110 via the bracket 170. That is, compared to the retainer 140 in the window glass receiving structures 100, 100A being fixed via the fixture 150, and the retainer 140B in the window glass receiving structure 100B being fixed via the inner flange 146, the retainer 140C in the window glass receiving structure 100C of the embodiment is fixed via the bracket 170. In this way, the retainer 140C may be supported by the frame component 110 having a high structural strength, and may be even more firmly supported by the frame component 110 by being fixed via the bracket 170 to the frame component 110. Moreover, by fixing the retainer 140C to the frame component 110 via the bracket 170, it is not necessary to form the retainer 140C and the frame component 110 integrally, which may enable the frame component 110 to form a smooth surface without compromising structural rigidity. However, the disclosure does not limit the fixing means of the retainer 140C and the frame component 110, or limit the specific structure (or setting) of the bracket 170, which may be adjusted according to requirements.

In summary, in the window glass receiving structure of the disclosure, the window glass receiving space is disposed between the end portion of the outer panel and the frame component to accommodate the window glass, and the retainer is disposed within the window glass receiving space to secure the seal of the window glass. In this way, the retainer is hidden inside the window glass receiving space without requiring the use of an additional component such as a garnish, thus enabling the window glass to be provided with a simple structure. Preferably, the outer flange of the retainer is clamped and fixed by the bent portion of the outer panel, thereby enhancing the structural strength. Accordingly, the window glass receiving structure of the disclosure may enhance appearance quality at a low cost.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. A window glass receiving structure, adapted to be disposed within a sashless door-type vehicle, comprising:
a frame component, having a closed cross section;
an outer panel, disposed on an outer side of the frame component to form an outer surface of the sashless door-type vehicle;
a window glass receiving space, disposed between an end portion of the outer panel and the frame component to receive window glass; and
a retainer, disposed within the window glass receiving space to secure a seal of the window glass.

2. The window glass receiving structure according to claim 1, wherein
the retainer has an outer flange, and is fixed to an inner side of the outer panel via the outer flange.

3. The window glass receiving structure according to claim 2, wherein
one end of the outer panel has a bent portion bent inwardly, and
the outer flange is clamped by the bent portion.

4. The window glass receiving structure according to claim 1, wherein
the retainer has an inner flange, and is fixed to the frame component via the inner flange.

5. The window glass receiving structure according to claim 1, wherein
the retainer is fixed to the frame component via a bracket mounted on the frame component.

6. The window glass receiving structure according to claim 1, wherein
the frame component has an opposing surface disposed opposite to a bottom of the retainer, and
the retainer is fixed to the opposing surface.

7. The window glass receiving structure according to claim 6, wherein
the retainer is fixed to the opposing surface via a fixture.

8. The window glass receiving structure according to claim 7, wherein
the fixture may adjust a fixed position of the retainer relative to the opposing surface.

9. The window glass receiving structure according to claim 7, wherein
the fixture has a lateral side that presses against the opposing surface and a sidewall of a through hole through which the fixture passes.
